(19) United States
(12) Patent Application Publication
(10) Pub. No.: US 2026/0212367 A1
(43) Pub. Date: Jul. 23, 2026

(54) UNIVERSAL IDENTIFIER PROCESSING USING SPLIT AUTHENTICATION AND AUTHORIZATION

(71) Applicant: Visa International Service Association, San Francisco, CA (US)

(72) Inventor: Kriti Ranjan Das, Singapore (SG)

(73) Assignee: Visa International Service Association, San Francisco, CA (US)

(21) Appl. No.: 19/453,723

(22) Filed: Jan. 20, 2026

Related U.S. Application Data
(60) Provisional application No. 63/748,872, filed on Jan. 23, 2025.

(51) Int. Cl. G06Q 20/40; G06Q 20/38

(52) U.S. Cl. CPC G06Q 20/4016; G06Q 20/3821

(57) ABSTRACT

A method is disclosed. The method includes receiving from a resource provider computer, an authorization request message comprising a universal identifier and an amount, determining a credential linked to the universal identifier, generating an authentication request message comprising the universal identifier, and transmitting, to a first authorizing entity computer, the authentication request message. The method also includes receiving, from the first authorizing entity computer, an authentication response message comprising an indicator of positive authentication, and then transmitting a subsequent authorization request message comprising the credential and the amount to a second authorizing entity computer. The method also includes receiving, from the second authorizing entity computer, an authorization response message comprising the credential, modifying the authorization response message to include the universal identifier instead of the credential, and transmitting, to the resource provider computer, the modified authorization response message.

### CROSS REFERENCE TO RELATED APPLICATIONS

This application is a PCT application which claims priority to U.S. Provisional Application No. 63/748,872, filed on Jan. 23, 2025, which is herein incorporated by reference in its entirety for all purposes.

### BACKGROUND

Many users have multiple user devices that can have different functions and features. It would be desirable to simplify the use of such user devices the individual users.

Further, the different user devices are also associated with risk evaluations and authentication processes respectively conducted different authorizing entities. While such authentication processes are effective in some instances, fraudulent actors continue to pose risks to using such user devices in transactions. For example, a fraudulent actor may have stolen a first credential of a legitimate user associated with a first account managed by a first authorizing entity. A transaction may be conducted using a second credential associated with a second account managed by a second authorizing entity. Since each credential is managed by a different authorizing entity, the second authorizing entity will not obtain information regarding the compromise of the user's first credential. As a result, there is a risk that the fraudulent actor may have compromised the second credential. However, the second authorizing entity may not take this into account in making its authorizing decision. It would be desirable to improve the security of existing transactions.

Embodiments of the present disclosure address these and other problems individually and collectively.

### SUMMARY

One embodiment is related to a processing network computer implemented method comprising: receiving, by a processing network computer from a resource provider computer, an authorization request message comprising a universal identifier and a value for a transaction conducted between a user and a resource provider operating the resource provider computer; determining, by the processing network computer, a credential linked to the universal identifier, the credential identifying an account at a second authorizing entity computer; generating, by the processing network computer, an authentication request message for the transaction; transmitting, by the processing network computer to a first authorizing entity computer, the authentication request message; receiving, by the processing network computer from the first authorizing entity computer, an authentication response message comprising an authentication result indicator; transmitting, by the processing network computer, the authorization request message comprising the credential, the value, and the authentication result indicator or a derivative thereof to a second authorizing entity computer; receiving, by the processing network computer from the second authorizing entity computer, an authorization response message comprising the credential and an authorization indicator; modifying, by the processing network computer, the authorization response message to include the universal identifier instead of the credential; and transmitting, by the processing network computer to the resource provider computer, the modified authorization response message.

Another embodiment of the invention includes a processing network computer comprising: a processor; and a computer readable medium, the computer readable medium comprising code, executable by the processor, for performing a method comprising: receiving, from a resource provider computer, an authorization request message comprising a universal identifier and a value for a transaction conducted between a user and a resource provider operating the resource provider computer; determining a credential linked to the universal identifier, the credential identifying an account at a second authorizing entity computer; generating an authentication request message for the transaction; transmitting, to a first authorizing entity computer, the authentication request message; receiving, from the first authorizing entity computer, an authentication response message comprising an authentication result indicator; transmitting the authorization request message comprising the credential and the value to a second authorizing entity computer; receiving, from the second authorizing entity computer, an authorization response message comprising the credential and an authorization indicator; and modifying the authorization response message to include the universal identifier instead of the credential; and transmitting, to the resource provider computer, the modified authorization response message.

Another embodiment of the invention includes a method comprising: receiving, by a second authorizing entity computer from a processing network computer, an authorization request message for a transaction between a user and a resource provider, the authorization request message comprising a credential, a value, and an authentication indicator generated by a first authorizing entity computer, or a derivative thereof; determining, by the second authorizing entity computer, whether the authorization request message is approved based on a credential, a value, and the authentication indicator generated by the first authorizing entity computer, or the derivative thereof; generating, by the second authorizing entity computer, an authorization response message comprising the credential and an authorization indicator; and transmitting, by the second authorizing entity computer to the processing network computer, the authorization response message.

Another embodiment of the invention includes a second authorizing entity computer comprising a processor; and a computer readable medium. The computer readable medium comprises code, executable by the processor, to perform a method comprising: receiving, from a processing network computer, an authorization request message for a transaction between a user and a resource provider, the authorization request message comprising a credential, a value, and an authentication indicator generated by a first authorizing entity computer, or a derivative thereof; determining whether the authorization request message is approved based on a credential, a value, and the authentication indicator generated by the first authorizing entity computer, or the derivative thereof; generating an authorization response message comprising the credential and an authorization indicator; and transmitting, to the processing network computer, the authorization response message.

Further details regarding embodiments of the disclosure can be found in the Detailed Description and the Figures.

### BRIEF DESCRIPTION OF THE DRAWINGS

FIG. 1 shows a method and system for linking credentials to a universal identifier to enroll a user.

FIG. 2 shows a method and system for configuring user preferences for default cards based on AI recommendations.

FIG. 3 shows a method and system for processing a transaction using a universal identifier linked to multiple credentials.

FIG. 4 shows a block diagram of a processing network computer according to an embodiment.

FIG. 5 shows an authorizing entity computer according to an embodiment.

### TERMS

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

The user device may also be a portable device comprising a substrate such as a paper or plastic card, and information that is printed, embossed, encoded, or otherwise included at or near a surface of an object. A portable device may be a payment device associated with a value such as a monetary value, a discount, or store credit, and a payment device may be associated with an entity such as a bank, a merchant, a payment processing network, or a person. Suitable payment devices can be hand-held and compact so that they can fit into a user's wallet and/or pocket (e.g., pocket-sized). Example payment devices may include smart cards, magnetic stripe cards, key fobs, etc. Other examples of payment devices include payment cards, smart media, transponders, and the like. If the payment device is in the form of a debit, credit, or smartcard, the payment device may also optionally have features such as magnetic stripes. Such devices can operate in either a contact or contactless mode.

An “access device” may be any suitable device for providing access to an external computer system. An access device may be in any suitable form. Some examples of access devices include point of sale (POS) devices, cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, Websites, and the like. An access device may use any suitable contact or contactless mode of operation to send or receive data from, or associated with, a portable communication device. In some embodiments, where an access device may comprise a POS terminal, any suitable POS terminal may be used and may include a reader, a processor, and a computer-readable medium. A reader may include any suitable contact or contactless mode of operation. For example, exemplary card readers can include radio frequency (RF) antennas, optical scanners, bar code readers, or magnetic stripe readers to interact with a portable communication device.

A “resource provider” may be an entity that can provide a resource such as goods, services, information, and/or access. Examples of resource providers includes merchants, data providers, transit agencies, governmental entities, venue, and dwelling operators, etc. A “merchant” may typically be an entity that engages in transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

“Credentials” may comprise any evidence of authority, rights, or entitlement to privileges. For example, access credentials may comprise permissions to access certain tangible or intangible assets, such as a building or a file. Examples of credentials may include passwords, passcodes, or secret messages. In another example, payment credentials may include any suitable information associated with and/or identifying an account (e.g., a payment account and/or payment device associated with the account). Such information may be related to the account or may be derived from information related to the account. Examples of account information may include an “account identifier” such as a PAN (primary account number or “account number”), a token, a subtoken, a gift card number or code, a prepaid card number or code, a user name, an expiration date, a CVV (card verification value), a dCVV (dynamic card verification value), a CVV2 (card verification value 2), a CVC3 card verification value, etc. An example of a PAN is a 16-digit number, such as “4147 0900 0000 1234”.

A “universal identifier” can include an identifier that can be universally used in place of items such as credentials issued by authorizing entity computers. For example, a user can use a universal identifier to conduct a transaction with a resource provider, instead of using the credentials. Thus, instead of a user using three different credentials issued by different authorizing entities for different transaction types, the user can use one universal identifier. The universal identifier can be in the form of a payment credential such as a PAN (primary account number) in some embodiments.

A “digital wallet” can store user profile information, payment information, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet so as to make a payment without having to enter an account number or present a physical card.

A “user identifier” can include any piece of data that can identify a user. A user identifier can comprise any suitable alphanumeric string of characters. In some embodiments, the user identifier may be derived from user identifying information. In some embodiments, a user identifier can include an account identifier associated with the user. For example, a user can be associated with an account, which has an account identifier, maintained by an authorizing entity computer. Examples of user identifiers can include e-mail addresses, phone numbers, identification numbers, usernames, etc.

A “token” may be a substitute value for a credential. A token may be a string of numbers, letters, or any other suitable characters. Examples of tokens include payment tokens, access tokens, personal identification tokens, etc.

“Tokenization” is a process by which data is replaced with substitute data. For example, a payment account identifier (e.g., a primary account number (PAN)) may be tokenized by replacing the primary account identifier with a substitute number (e.g., a token) that may be associated with the payment account identifier. Further, tokenization may be applied to any other information that may be replaced with a substitute value (i.e., token). Tokenization enhances transaction efficiency and security.

A “cryptogram” may include a piece of obscured text such as encrypted text. A cryptogram may be formed by encrypting input data with an encryption key such as a symmetric encryption key. In some embodiments, a cryptogram is reversible so that the inputs that are used to form the cryptogram can be obtained using the same symmetric key to perform a decryption process. In some embodiments, if input data is encrypted using a private key of a public/private key pair, the cryptogram may also be a digital signature. A digital signature may be verified with a public key of the public/private key pair. In some embodiments, a cryptogram may include a dCVV (dynamic card verification value).

In some embodiments, the cryptogram can encode data elements including an account identifier such as primary account number, a variable data element such as a counter, a time of day, or interaction value, and other information. Such data may be included using an encryption process such as DES, triple DES, or AES using suitable encryption keys. The encryption keys may also be UDKs or unique derived keys, and may be generated based upon device specific information such as an account number, which may be encrypted using a master derivation key (MDK). The cryptogram can be verified by another computer such a remote computer by either decrypting the cryptogram to and verifying the decrypted contents with other data (e.g., an account number stored on file), or by encrypting other inputs and then comparing the encrypted result to the cryptogram.

A “processing network computer” may be a computer that can be part of a processing network such as a payment processing network. A processing network may include data processing subsystems, networks, and operations. In embodiments of the invention, a processing network may be used to support and deliver authorization services, exception file services, and clearing and settlement services. A processing network may be a payment processing network able to transmit and receive financial system transaction messages (e.g., ISO 8583 messages), and process original credit and debit card transactions. An exemplary payment processing system may include VisaNet™. Payment processing systems such as VisaNet™ are able to process credit card transactions, debit card transactions, and other types of commercial transactions.

A “clearing and settlement process” may include a process of reconciling a transaction. A clearing process is a process of exchanging financial details between an acquirer and an issuer to facilitate posting to a party's account and reconciliating the party's settlement position. Settlement involves the delivery of funds from one party to another.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may be coupled to a database and may include any hardware, software, other logic, or combination of the preceding for servicing the requests from one or more client computers.

An “authorization request message” may be an electronic message that requests authorization for an interaction. In some embodiments, it is sent to a transaction processing computer and/or an issuer of a payment card to request authorization for a transaction. An authorization request message according to some embodiments may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a username, an expiration date, etc. An authorization request message may also comprise “transaction information,” such as any information associated with a current transaction, such as the transaction value, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request message. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g., POS equipment) that indicates approval of the transaction. The code may serve as proof of authorization.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

The term “verification” and its derivatives may refer to a process that utilizes information to determine whether an underlying subject is valid under a given set of circumstances. Verification may include any comparison of information to ensure some data or information is correct, valid, accurate, legitimate, and/or in good standing.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron, and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

### DETAILED DESCRIPTION

Embodiments of the invention can use a universal identifier that can be used by a first authorizing entity computer to authenticate a transaction, while a second authorizing entity computer managing a real credential or token associated with the universal identifier can also authenticate the transaction and authorize the transaction. This results in multiple authorizing entity computers authenticating a single transaction, thereby improving data security.

Embodiments of the invention can also provide for systems and methods that can optimize benefits from various sources during transactions using a universal identifier. In some embodiments, a user can link their existing credentials to the universal identifier through a mobile application and select preferred credentials according to different benefits that might be provided through the use of such credentials. In other embodiments, an artificial intelligence engine can suggest the optimal credential for a transaction, based on the resource provider that the user is interacting with, a transaction value (e.g., a transaction amount), and available benefits.

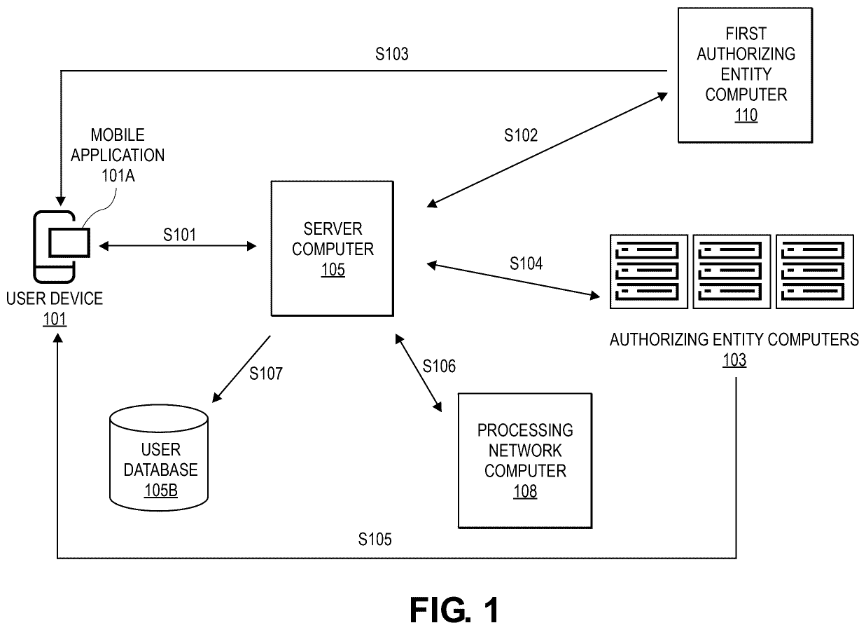

FIG. 1 shows a system and a corresponding method for linking credentials to a universal identifier to enroll a user via a mobile application. The system in FIG. 1 includes a server computer 105 in communication with a first authorizing entity computer 110 operated by a first authorizing entity, a plurality of authorizing entity computers 103 a mobile application 101A on a user device 101 operated by a user (not shown), a user database 105B, and a processing network computer 108. The user device 101 can be in the form or a mobile phone, a payment card, etc. The first authorizing entity computer 110 and each of the plurality of authorizing entity computers 103 may be operated by different authorizing entities (e.g., financial institutions) that have accounts (e.g., credit, debit, or stored value accounts) of the user operating the user device 101. For example, the first authorizing entity operating a first authorizing entity computer can issue a credit card (e.g., physical, or virtual) to the user, while a second authorizing entity operating a second authorizing entity computer can issue a debit card (e.g., physical, or virtual) to the same user.

The mobile application 101A may also be used to stop transactions, report stolen cards, configure card preferences, benefits, view promotions, loyalty points, transaction history, and can integrate with other applications (e.g., bill payment applications).

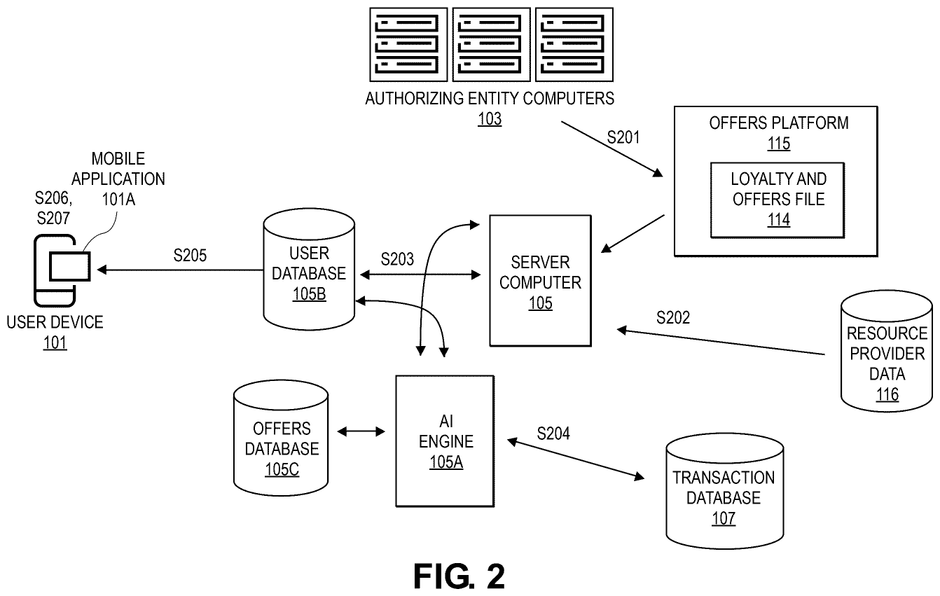

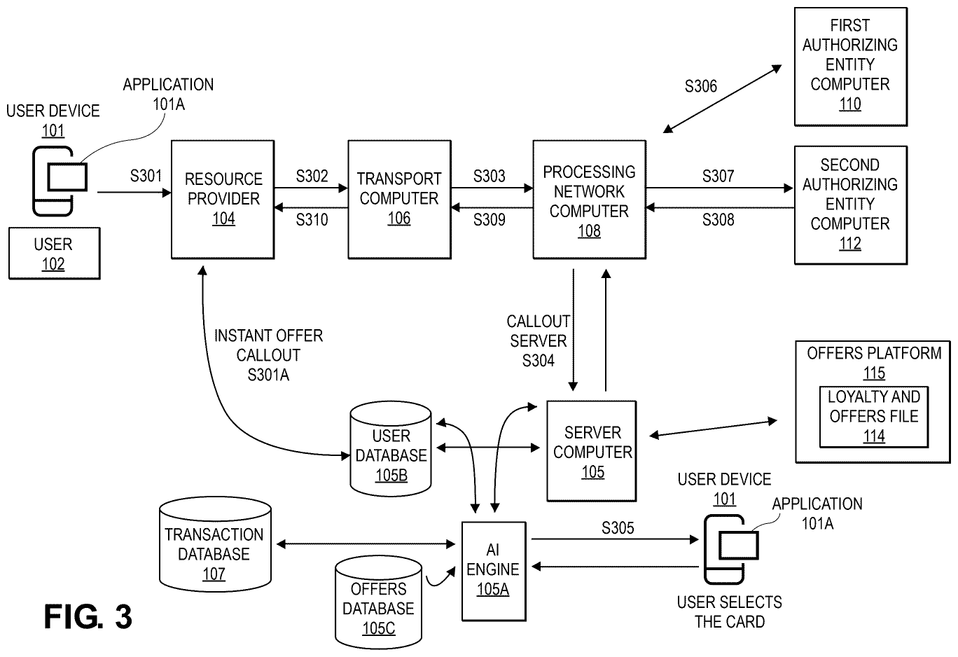

Messages between the devices and the computers in the system in FIG. 1 (as well as FIGS. 2 and 3) can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583), and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

In step S101, the user may use the user device 101 to submit an enrollment request with the server computer 105. The user may enroll by providing a mobile phone number and the universal identifier. The universal identifier may be primary account number (or token of the primary account number) associated with an account managed by the first authorizing entity operating the first authorizing entity computer 110. The universal identifier may have been issued by the first authorizing entity or the entity operating the server computer 105 prior to step S101.

In step S102, the server computer 105 can transmit an authentication request message comprising the universal identifier and any other relevant details to the first authorizing entity computer 100.

In step S103, the first authorizing entity computer 110 can authenticate the user via the mobile application 101A on the user device 101. For example, the first authorizing entity computer 110 can request that the user of the user device 101 input a shared secret or a biometric into the mobile application 101A, and the first authorizing entity computer 110 can authenticate the user by comparing this data with previously stored user registration data. The first authorizing entity computer 110 can then pass a result of the authentication to the server computer 105. The result of the authentication can be in the form of an authentication indicator.

In step S104, upon receiving a positive authentication indicator from the first authorizing entity computer 110, the server computer 105 can retrieve credential details from the participating authorizing entities (e.g., Issuer 1, Issuer 2, Issuer 3) operating the plurality of authorizing entity computers 103 with which the user has accounts. The server computer 105 can send credential request messages including one or more user identifiers (e.g., a phone number, e-mail address, etc.) to the plurality of authorizing entity computers 103. In response, the plurality of authorizing entity computers 103 can rely with any credentials associated with the one or more user identifiers. The server computer 105 can then link the credential details of the received to a universal identifier.

In some embodiments, in step S106, the server computer 105 may request that the processing network computer 108 determine each of the participating authorizing entities that the user has accounts with based on user identifiers (e.g., a phone number, an address) associated with the user. The server computer 105 can request user credential and account information from each of the participating authorizing entities. Prior to sharing credential details, the participating authorizing entities may additionally authenticate the user. After authentication, the participating authorizing entities can share the credential and account details for the user via an API (e.g., an Open Banking API).

In step S107, the server computer 105 can store the credential details with the universal identifier in a user database 105B.

After enrolling, the user can configure credential preferences for credentials linked to the universal identifier in the mobile application 101A. The mobile application 101A or the server computer 105 can suggest which credential to use for every transaction in order to optimize benefits. The user can configure designated credentials for various categories, or default to whichever credential is recommended by an AI (artificial intelligence) engine. For example, one particular credential may be more advantageous for the user to use in gas purchase transactions, because the use of the credential provides greater rewards for gas purchases than other credentials. On the other hand, another credential may be more advantageous for the user to use in dining purchases, because the use of the another credential can provide greater rewards for dining purchases than other credentials.

FIG. 2 shows a method and system for configuring different credentials for various transaction categories using AI recommendations. The server computer 105 can assess credentials against offers and loyalty files 114 in an offers platform 115 provided by participating authorizing entity computers 103 and resource provider data 116 provided by resource providers to suggest the best credentials for each category of purchase.

In steps S201 and S202, participating authorizing entities and resource providers can push loyalty files and offers to an offers database 105C. In step S203, the server computer 105 can use the AI engine 105A to analyze the data in the offers database 105C and data in a user database 105B. In step S204, the AI engine 105A can analyze the data in the offers database 105C, the credential data for the credentials linked to the universal identifier of the user (e.g., in the user database 105B), and the user's transaction history (e.g., in a transaction database 107). For example, the AI engine 105A can assess the resource providers that the user most frequently transacts with to determine the best offers and loyalties for the user, and output recommendations to the user.

In step S205, the server computer 105 may provide the recommendations to the user. In steps S206 and S207, the user may configure default credentials according to the recommendations. In some embodiments, the user may receive recommendations and configure default credentials for certain transaction types in the mobile application 101A. Additionally or alternatively, the user use the AI engine 105A to recommend and/or select the optimal credential for a transaction.

In embodiments of the invention, the mobile application 101A can enable enrolled users to initiate a transaction with the universal identifier. As noted above, in some embodiments, the application 101A and/or the server computer 105 can select the best credential or prompt the user to select the credential for the transaction. In embodiments of the invention, the first authorizing entity can perform authentication processing with respect to the universal identifier, and the second authorizing entity can perform authorization processing and optionally additional authentication processing with respect to selected credential.

FIG. 3 shows a method and system for processing a transaction using a universal identifier linked to multiple credentials. FIG. 3 shows a user 102 and a resource provider 104 (e.g., a merchant) conducting a transaction using a universal identifier. The resource provider 104 can operate a resource provider computer such as an access device (e.g., a POS terminal or a merchant Web server). FIG. 3 also shows a processing network computer 108 in communication with a transport computer 106, a first authorizing entity computer 110, a second authorizing entity computer 112, and a server computer 105. The first authorizing entity computer 110 may manage and issue the universal identifier on behalf of the user 102. The second authorizing entity computer 112 may manage one or more accounts and/or issuer one or more credentials for the one or more accounts on behalf of the user 102.

The server computer 105 may manage a user database 105B comprising user profile data (e.g., credential details and user information), and an offers database 105C comprising loyalty and offer data. An offers platform 115 can enable authorizing entities and resource providers to provide loyalty and offers, which are pushed to server computer 105 and stored in the offers database 105C. The server computer 105 may use an AI engine 105A to recommend and manage selected credentials for transactions. In some embodiments, the AI engine 105A, the user database 105B, the offers database 105C, and/or the transaction database 107 may be part of the server computer 105 or part of an overall system that includes the server computer 105.

According to embodiments, the payment initiation and acceptance can user existing communication protocols and infrastructure. The resource provider 104 and transport computer 106 do not need to make significant modifications to messaging systems and protocol.

During authorization, the user 102 can provide a universal identifier (e.g., via a card tap) to the resource provider 104 to conduct a transaction. The server computer 105 can obtain the optimal credential or prompt the user (e.g., via a mobile application) to select a recommended credential for the transaction.

The universal identifier can be in the form of a PAN or primary account number on a portable device, and may be linked to one or more credentials during an enrollment process as described above and illustrated in FIG. 2. The linked credentials can include debit cards, credit cards, prepaid cards, wallet identifiers, bank account identifiers, cryptocurrency wallet identifiers, etc.

At step S301, the transaction is initiated. The user 102 may wish to obtain a resource from the resource provider 104. The user can provide the universal identifier to the resource provider 104 to initiate a transaction. For example, the universal identifier may be on a user device 101 such as a payment device (e.g., user's payment card, etc.) and the user may interact (e.g., tap or insert) the user device 101 with a resource provider computer operated by the resource provider 104. Data can be exchanged between the resource provider computer and the user device 101.

The user device 101 can also generate a cryptogram. The cryptogram can be generated by encrypting data elements including one or more of the universal identifier, the value of the transaction, a counter, etc. The cryptogram can encode data from the user device 101 and the resource provider computer to establish that the current transaction is being conducted between them. Later verification of the cryptogram ensures that the elements of the transaction being match the data elements, and that the transaction was not derived from a man-in-the-middle attack.

At steps S302 and S303, the resource provider computer can also generate an authorization request message including, but not limited to, the universal identifier, an expiration date, a security code, a value for the transaction, a resource provider identifier, and the cryptogram. The resource provider computer then transmits the authorization request message to the processing network computer 108 via the transport computer 106. The processing network computer 108 can then receive from the resource provider computer, the authorization request message.

At step S304, after receiving the authorization request message comprising the amount and the universal identifier, the processing network computer 108 can determine a credential linked to the universal identifier. To determine the credential, the processing network computer 108 can transmit a callout to the server computer 105 and the server computer 105 can determine preferred credential to conduct the current transaction. For example, the credential that is linked to the universal identifier can be a credential (e.g., an account number) that is associated with an account managed by the second authorizing entity computer 112.

In some embodiments, the credential that is determined may be a default credential. For example, if the transaction has a default credential, the credential may be determined according to the user's pre-selected preference. If there is no default credential, the credential may be determined by the AI engine 105A or using some other logic.

Upon receiving the callout request from the processing network computer 108 the server computer 105 can first check the user database 105B for a default credential. In some embodiments, the user database 105B may comprise a PAN (primary account number) Ref (reference), a linked PAN Ref list, a masked PAN list, a default PAN indicator, product IDs of PANs, authorizing entity logos / designs for each PAN, etc. If there is a default credential for the transaction, the server computer 105 can transmit the default credential in a reply to the processing network computer 108.

If there is no default credential, the server computer 105 can use the AI engine 105A (or other logic) to determine a suitable credential (e.g., associated with a preferred payment card account) for the current transaction. In some embodiments, the AI engine 105A can determine the credential that would provide the best rewards for the user 102 in the current transaction. In such embodiments, the server computer 105 can transmit the universal identifier to the AI engine 105A, and the AI engine 105A may use data in the user database 105B (e.g., list of cards and card details), the transaction database 107 (e.g., historical transaction data), and offers database 105C to determine the optimal credential of the user for the transaction.

In other embodiments, the user 102 may determine the credential to use in the current transaction. For example, at step S305, the AI engine 105A or the server computer 105 can contact the user 102 via the user device 101. The AI engine 105A or the server computer 105 can present a set of credentials from which the user may select for conducting the current transaction. The user device 101 can transmit the selected credential to the AI engine 105A and/or the server computer 105. The server computer 105 can then transmit the selected credential in a response to the processing network computer 108.

At step 306, after the credential is determined, the processing network computer 108 generates an authentication request message comprising the universal identifier and transmits it to a first authorizing entity computer 110. The authentication request message can also optionally include the value for the transaction (e.g., a transaction amount), a cryptogram for the transaction, and any authentication data of the user or the user device 101.

The first authorizing entity computer 110 authenticates the transaction, the user, the transaction, and/or the universal credential. The first authorizing entity computer 110 can perform any suitable authentication processing. For example, the first authorizing entity computer 110 can verify authentication data such as password in the authorization request message to a stored password of the user. In another example, the first authorizing entity computer 110 could send an out of band message such as a one-time password to the user's communication device to confirm that the user is conducting the transaction.

In another example, the first authorizing entity computer 110 can validate the cryptogram. The validation of the cryptogram can occur in different ways. For example, in some embodiments, the first authorizing entity computer 110 can generate or obtain a symmetric key that corresponds to a symmetric key that was used to create the first cryptogram. The first authorizing entity computer 110 can then encrypt inputs including the universal identifier, value for the transaction, etc. to form a cryptogram, which may be compared to the cryptogram received in the authorization request message. If they match, then the first token cryptogram is validated. In other embodiments, the cryptogram in the authorization request message can be decrypted to obtain its inputs. The plaintext inputs can then be compared to other plaintext inputs to determine if they match. If they match, then the cryptogram is validated.

The first authorizing entity computer 110 then generates an authentication indicator that indicates the result of the authentication processing. The authentication indicator can be in the form of a binary value (e.g., “0” for not authenticated and “1” for authenticated), a variable value such as a score, or a set of values pertaining to authentication). The first authorizing entity computer 110 then provides an authentication response message with a positive authentication indicator to the processing network computer 108. The first authorizing entity computer 110 can optionally pass its authentication capabilities to the processing network computer 108.

The communications in step S306 may occur via an API, or may occur via authorization protocols such as ISO 8583 in some cases. For example, in the latter case, the authentication request message may be in the form of an authorization request message with a zero dollar amount or a null amount. The processing network computer 108 can transmit the authorization request message comprising the universal identifier, the zero or null amount, and the cryptogram to the first authorizing entity computer 110. The first authorizing entity computer 110 can then perform authentication processing to authenticate the user 102 as noted above. This embodiment has advantages in that a new communication path or protocol need not be established between the first authorizing entity computer 110 and the processing network computer 108 in transactions involving multiple authorizing entity computers.

At step 307, after receiving the authentication indicator, the processing network computer 108 then modifies the authorization request message to include at least the selected credential account, the value, and authentication indicator generated by the first authorization entity computer 110 or a derivative thereof. In some embodiments, the authentication indicator may be included in the authorization request message that is sent to the second authorizing entity computer 112. In other embodiments, a derivative of the authentication indicator may be included in the authorization request message that is sent to the second authorizing entity computer 112. For example, the processing network computer 108 can generate a fraud score using the authentication indicator generated by the first authorization entity computer 110 and other data that it may have in its possession.

The processing network computer 108 then transmits the modified authorization request message to the second authorizing entity computer 112 for authorization.

The second authorizing entity computer 112 can then determine whether or not the transaction is authorized. The second authorizing entity computer 112 can authenticate and/or evaluate the transaction, the user and/or the account associated with the selected credential, the authentication indicator generated by the first authorizing entity computer 110, or derivative thereof, in determining whether or not the transaction is authorized. The second authorizing entity computer 112 can also determine if the account associated with the credential in the authorization request message has sufficient funds or credit to pay for the value of the current transaction. The second authorizing entity computer 112 can then generate an authorization indicator indicating whether the transaction is authorized or not, and can generate an authorization response message including the selected credential and the authorization indicator. The second authorizing entity computer 112 can then transmit the authorization response message to the processing network computer 108.

At step S309, upon receiving the authorization response message from the second authorizing entity computer 112, the processing network computer 108 may modify the authorization response message to include the universal identifier instead of the credential prior to transmitting it to the resource provider 104.

At step S310, the processing network computer 108 can transmit the modified authorization response message comprising the universal identifier to the resource provider 104 via the transport computer 106.

In various embodiments, the server computer 105 can integrate with the resource provider 104 through APIs to enable the selection of an optimized benefit during checkout. During checkout, the user 102 can prompt the resource provider 104 to submit an instant offer callout to the server computer 105. For example, the user 102 may browse and shop via a resource provider application. During checkout, the user 102 can indicate that they wish to pay using a universal identifier, and select a benefit they wish to use for the transaction. The resource provider 104 can receive the selected offer and the universal identifier from the user 102.

Then, the resource provider 104 can query if the selected offer can be applied. The resource provider 104 may transmit the universal identifier and an offer identifier of the selected offer to the server computer 105 (e.g., step 301A). The server computer 105 can identify a plurality of credentials linked to the universal identifier and determine that the selected offer can be applied to a qualifying credential in the plurality of credentials. The server computer 105 can notify the resource provider 104 that the selected offer can be applied and transmit an offer identifier which references the qualifying credential to the resource provider 104. The resource provider 104 can apply a discount or benefit on the transaction according to the selected offer. For example, the resource provider 104 can reduce the amount for the requested resource and insert the reduced value for the transaction in the authorization request message. The resource provider 104 can also optionally include the offer identifier in the authorization request message.

The offer identifier may be stored in association with the credential in the offers database 105C, so that when the processing network computer 108 receives the authorization request message comprising the optimized offer, it can resolve the optimized offer to the qualifying credential via the server computer 105. The processing network computer 108 can then submit the qualifying credential for authorization (e.g., to a second authorizing entity computer 112). The second authorizing entity computer 112 can then reduce the amount of the transaction according to the offer identifier or other information and/or provide some other benefit to the user (e.g., provide the user with an increased number of points for the transaction).

At the end of the day or any suitable period of time, the processing network computer 108 can facilitate a clearing and settlement process between the transport computer 106, the first authorizing entity computer 110, and the second authorizing entity computer 112.

After the authorizing processing in FIG. 3, a clearing and settlement process can take place between the transport computer 106, the first authorizing entity computer 110, the second authorizing entity computer 112, and the processing network computer 108. Advantageously, in some embodiments, the transport computer 106 does not need to accommodate the use of a universal identifier in a transaction, and can submit clearing drafts according to existing protocol and rails. Upon receiving the clearing draft, the processing network computer 108 can split interchange among the first authorizing entity computer 110 and the second authorizing entity computer 112. The transaction can be cleared and settled with the second authorizing entity computer 112.

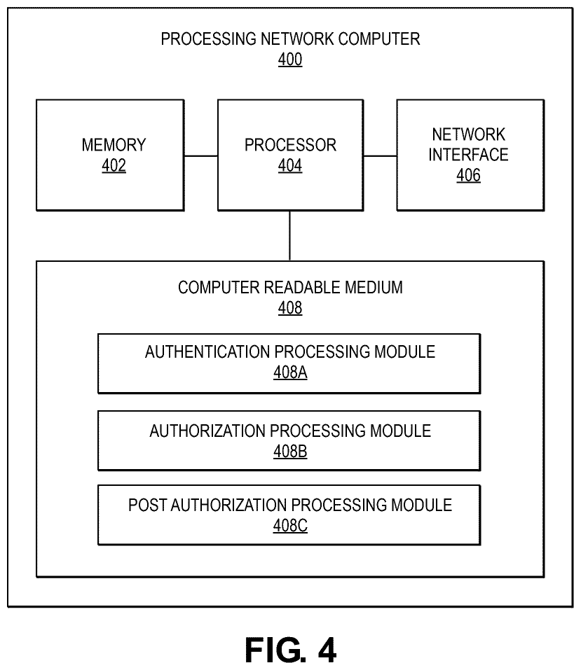

FIG. 4 shows a block diagram of a processing network computer 400 according to embodiments. The exemplary processing network computer 400 may comprise a processor 404. The processor 404 may be coupled to a memory 402, a network interface 406, and a computer readable medium 408. The computer readable medium 408 can comprise an authentication processing module 408A, an authorization processing module 408B, and a post authorization processing module 408C.

The computer readable medium 408 may comprise code, executable by the processor 404, for performing a method comprising: receiving, from a resource provider computer, an authorization request message comprising a universal identifier and a value for a transaction conducted between a user and a resource provider operating the resource provider computer; determining a credential linked to the universal identifier, the credential identifying an account at a second authorizing entity computer; generating an authentication request message for the transaction; transmitting, to a first authorizing entity computer, the authentication request message; receiving, from the first authorizing entity computer, an authentication response message comprising an authentication result indicator; transmitting the authorization request message comprising the credential and the value to a second authorizing entity computer; receiving, from the second authorizing entity computer, an authorization response message comprising the credential and an authorization indicator; modifying the authorization response message to include the universal identifier instead of the credential; and transmitting, to the resource provider computer, the modified authorization response message

The authentication processing module 408A may comprise code or software, executable by the processor 404, for performing authentication processing.

The authorization processing module 408B in conjunction with the processor 404, can perform authorization processing.

The post authorization processing module 408C, in conjunction with the processor 404, can perform post authorization processing such as clearing and settlement processing.

The network interface 406 may be any suitable combination of hardware and software that enables data to be transferred. Some examples of the network interface 406 may include a modem, a physical network interface (such as an Ethernet card or other Network Interface Card (NIC)), a virtual network interface, a communications port, a Personal Computer Memory Card International Association (PCMCIA) slot and card, a wireless communication interface, and/or the like.

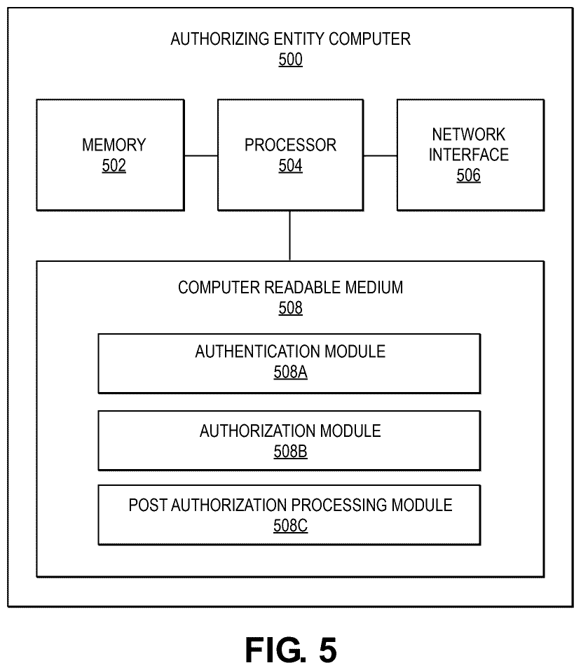

FIG. 5 shows a block diagram of an authorizing entity computer 500 according to embodiments. The exemplary authorizing entity computer 500 may comprise a processor 504. The processor 504 may be coupled to a memory 502, a network interface 506, and a computer readable medium 508. The computer readable medium 508 can comprise an authentication processing module 508A, an authorization processing module 508B, and a post authorization processing module 508C.

The computer readable medium 508 may comprise code, executable by the processor 504, for performing a method comprising: receiving, from a processing network computer, an authorization request message for a transaction between a user and a resource provider, the authorization request message comprising a credential, a value, and an authentication indicator generated by a first authorizing entity computer, or a derivative thereof, to a second authorizing entity computer; determining whether the authorization request message is approved based on a credential, a value, and an authentication indicator generated by the first authorizing entity computer, or the derivative thereof; generating an authorization response message comprising the credential and an authorization indicator; and transmitting, by the second authorizing entity computer to the processing network computer, the authorization response message.

The authentication processing module 508A may comprise code or software, executable by the processor 504, for performing authentication processing.

The authorization processing module 508B in conjunction with the processor 404, can perform authorization processing. The authorization processing module 508B can include may comprise code or software, executable by the processor 404, for authorizing interactions. The authorization processing module 508B, in conjunction with the processor 404, can determine whether or not to authorize an interaction between a user device and a resource provider computer. The authorization processing module 508B, in conjunction with the processor 404, can evaluate an account maintained by the first authorizing entity computer 110 on behalf of the user of the user device to determine if the user has sufficient funds for the interaction. The authorization processing module 508B, in conjunction with the processor 404, can determine whether or not to authorize the interaction based on any suitable data, for example, user fund amounts, fraud rates, interaction request rates, amount sizes, credit limits, expiry dates, etc.

The post authorization processing module 508C, in conjunction with the processor 404, can perform post authorization processing such as clearing and settlement processing.

The network interface 506 may be similar to the network interface 406 and will not be repeated here.

Embodiments of the disclosure have a number of technical advantages. As shown above, embodiments enable access to a plurality of credentials during a transaction using a universal identifier. Users can automatically receive optimized benefits for every transaction. Embodiments are compatible with existing acceptance ecosystems, so that transport computers and resource providers do not need to incorporate additional messaging. Furthermore, embodiments provide secure transaction processing by limiting the exposure of credentials.

Further, embodiments of the invention allow multiple authorizing entity computers to authenticate and authorize a single transaction. The authentication of the user using the universal identifier and the authentication of the user using the selected credential for the transactions improves the overall data security for the transaction, relative to conventional methods.

Although the steps in the flowcharts and process flows described above are illustrated or described in a specific order, it is understood that embodiments of the invention may include methods that have the steps in different orders. In addition, steps may be omitted or added and may still be within embodiments of the invention.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A method comprising:
receiving, by a processing network computer from a resource provider computer, an authorization request message comprising a universal identifier and a value for a transaction conducted between a user and a resource provider operating the resource provider computer;
determining, by the processing network computer, a credential linked to the universal identifier, the credential identifying an account at a second authorizing entity computer;
generating, by the processing network computer, an authentication request message for the transaction;
transmitting, by the processing network computer to a first authorizing entity computer, the authentication request message;
receiving, by the processing network computer from the first authorizing entity computer, an authentication response message comprising an authentication result indicator;
transmitting, by the processing network computer, the authorization request message comprising the credential, the value, and the authentication result indicator or a derivative thereof to the second authorizing entity computer;
receiving, by the processing network computer from the second authorizing entity computer, an authorization response message comprising the credential and an authorization indicator;
modifying, by the processing network computer, the authorization response message to include the universal identifier instead of the credential; and
transmitting, by the processing network computer to the resource provider computer, the modified authorization response message.

2. The method of claim 1, wherein the credential is a second credential, the account is a second account, and the authentication request message comprises the universal identifier, the universal identifier being in the form of a first credential that identifies a first account managed by the first authorizing entity computer.

3. The method of claim 1, wherein the credential is a second credential, the account is a second account, and the processing network computer also:
determines a first credential associated with the universal identifier, and the authentication request message comprises the first credential, the first credential identifying a first account managed by the first authorizing entity computer.

4. The method of claim 1, wherein the authentication request message is provided to the first authorizing entity computer via an API (application programming interface).

5. The method of claim 1, wherein the authorization request message is a second authorization request message, and the authentication request message is in the form of a first authorization request message comprising a zero or null value in value data field and the universal identifier in an account identifier data field.

6. The method of claim 5, wherein the first authorization request message and the second authorization request message are each in an ISO 8583 data format.

7. The method of claim 1, wherein the processing network computer stores a set of at least three credentials associated with the universal identifier, each credential associated with a different authorizing entity computer.

8. The method of claim 1, wherein determining the credential linked to the universal identifier comprises:
transmitting, by the processing network computer, a credential selection request message to a user device operated by the user; and
receiving, by the processing network computer, a credential selection response message comprising the credential.

9. The method of claim 1, wherein determining the credential linked to the universal identifier comprises automatically selecting, by the processing network computer, the credential based on preferences of the user.

10. The method of claim 9, wherein the preferences comprise a linkage between the resource provider and the credential.

11. The method of claim 1, wherein the universal identifier is in the form of a token.

12. The method of claim 1, wherein the processing network computer stores a set of at least three credentials associated with the universal identifier, each credential associated with a different authorizing entity computer, and wherein the method further comprises:
receiving, by the processing network computer from the resource provider computer, an offer request message; and
providing, by the processing network computer to the resource provider computer, available offers associated with the set of at least three credentials.

13. The method of claim 12, wherein the resource provider computer applies an offer associated with the selected credential to the transaction.

14. A processing network computer comprising:
a processor; and
a computer readable medium, the computer readable medium comprising code, executable by the processor, for performing a method comprising:
receiving, from a resource provider computer, an authorization request message comprising a universal identifier and a value for a transaction conducted between a user and a resource provider operating the resource provider computer;
determining a credential linked to the universal identifier, the credential identifying an account at a second authorizing entity computer;
generating an authentication request message for the transaction;
transmitting, to a first authorizing entity computer, the authentication request message;
receiving, from the first authorizing entity computer, an authentication response message comprising an authentication result indicator;
transmitting the authorization request message comprising the credential and the value to the second authorizing entity computer;
receiving, from the second authorizing entity computer, an authorization response message comprising the credential and an authorization indicator;
modifying the authorization response message to include the universal identifier instead of the credential; and
transmitting, to the resource provider computer, the modified authorization response message.

15. A method comprising:
receiving, by a second authorizing entity computer from a processing network computer, an authorization request message for a transaction between a user and a resource provider, the authorization request message comprising a credential, a value, and an authentication indicator generated by a first authorizing entity computer, or a derivative thereof;
determining, by the second authorizing entity computer, whether the authorization request message is approved based on the credential, the value, and the authentication indicator generated by the first authorizing entity computer, or the derivative thereof;
generating, by the second authorizing entity computer, an authorization response message comprising the credential and an authorization indicator; and
transmitting, by the second authorizing entity computer to the processing network computer, the authorization response message.

16. The method of claim 15, wherein the derivative thereof is a fraud score based on the authentication indicator generated by the first authorizing entity computer.

17. The method of claim 15, wherein the authorization request message is an ISO 8583 message.

18. The method of claim 15, wherein the credential is a second credential associated with a second account managed by the second authorizing entity computer, and the first authorizing entity computer manages a first account associated with a first credential of the user.

19. The method of claim 15, wherein the processing network computer is programmed to store a set of at least three credentials associated with a universal identifier, each credential associated with a different authorizing entity computer.

20. The method of claim 15, further comprising:
receiving, by the second authorizing entity computer, a credential request message comprising a communication identifier of the user;
determining, by the second authorizing entity computer, the credential using the communication identifier; and
providing, by the second authorizing entity computer, the credential to the processing network computer.
